(19) United States
(12) Patent Application Publication
(10) Pub. No.: US 2010/0263806 A1
(43) Pub. Date: Oct. 21, 2010

(54) Venetian blind system

(76) Inventors: Jack Gindlesperger, Windber, PA (US); Brian Gindlesperger, Windber, PA (US); Mark Gindlesperger, Windber, PA (US)

Correspondence Address: EMERY L. TRACY, P.O. BOX 1518, BOULDER, CO, 80306, US

(21) Appl. No.: 12/798,955

(22) Filed: Apr. 14, 2010

Related U.S. Application Data
(60) Provisional application No. 61/212,748, filed on Apr. 15, 2009.

(51) Int. Cl. E06B 9/386; E06B 9/28; E06B 9/36

(52) U.S. Cl. 160/174 V; 160/176.1 R; 160/405

(57) ABSTRACT

A venetian blind system for blocking the sun through a window is provided. The venetian blind system comprises a plurality of blind slats. A tinting mechanism tints each of the blind slats. A turning mechanism turns the blind slats from a substantially open position to a substantially closed position. A moving mechanism moves the blind slats in a generally upward and downward direction wherein upon the blind slats being in a substantially closed position, any objects viewed through the window are clearly visible.

The present application claims the benefit of priority of pending provisional patent application Ser. No. 61/212,748, filed on Apr. 15, 2009, entitled “Polarized Venetian Blinds”.

### BACKGROUND OF THE INVENTION

1. Field of the Invention

This invention relates generally to a venetian blind system and, more particularly, the invention relates to a venetian blind system enabling the user to enjoy the sun blocking benefits of the tinted and/or polarized venetian blinds without obstructing their view of the outdoors.

2. Description of the Prior Art

A basic, functional element of any home decor is a window. Windows can set the tone for a room, creating a pleasant mood through bright, sunny light and a direct view of the outdoors. Because windows let in vibrant sunshine, most consumers find it necessary to mount window blinds inside their windows, in order to offer necessary shade.

Additionally, window blinds are used to protect the homeowner's privacy, particularly in the evening hours when light shining from overhead lights and floor lamps illuminate through the window, offering passersby a free view into the home. Produced in a variety of sizes and colors, as well as a broad selection of materials such as aluminum, plastic and wood, window blinds are a necessary item found in most households.

Although indeed a practical necessity, use of window blinds is not without drawbacks. Specifically, during daylight hours window blinds may indeed block out the intense light of the sun, but in doing so they also completely obstruct one's view of the outdoors. Should one wish to enjoy the view of a flower garden, well-manicured lawn or simply the neighborhood street during the daytime, they have no other choice but to leave the blinds open. Letting in the brilliant sunlight by opening a set of window blinds can cause temperatures to quickly rise in the home, resulting in higher cooling bills during the summer months. Further, when blinds are left open during the daylight hours the glare of the sun can cause a serious distraction, particularly if one is trying to enjoy a television program or is utilizing a household computer.

### SUMMARY

The present invention is a venetian blind system for blocking the sun through a window. The venetian blind system comprises a plurality of blind slats. A tinting mechanism tints each of the blind slats. A turning mechanism turns the blind slats from a substantially open position to a substantially closed position. A moving mechanism moves the blind slats in a generally upward and downward direction wherein upon the blind slats being in a substantially closed position, any objects viewed through the window are clearly visible.

In addition, the present invention includes a method for blocking the sun through a window. The method comprises providing a plurality of blind slats, tinting each of the blind slats, turning the blind slats from a substantially open position to a substantially closed position, and objects through the window are clearly visible.

The present invention further includes a venetian blind system for blocking the sun through a window. The venetian blind system comprises a plurality of blind slats, each of the blind slats being tinted with the tint reducing glare and filtering ultraviolet rays. A reflective coating is applied to at least one side of each of the blind slats with the reflective coating obstructing passersby from looking in wherein upon the blind slats being in a substantially closed position, any objects viewed through the window are clearly visible from the inside looking out.

### BRIEF DESCRIPTION OF THE DRAWINGS

FIG. 1 is a perspective view illustrating a venetian blind system, constructed in accordance with the present invention;

FIG. 2 is another perspective view illustrating the venetian blind system of FIG. 1, constructed in accordance with the present invention;

FIG. 3 is an end view illustrating an embodiment of the venetian blind system, constructed in accordance with the present invention, with each blind slat having a slanted edge and the tint applied to the entire length of the blind slat;

FIG. 4 is an end view illustrating another embodiment of the venetian blind system, constructed in accordance with the present invention, with the blind slats overlapping and only a portion of the blind slat being tinted; and

FIG. 5 is an end view illustrating still another embodiment of the venetian blind system, constructed in accordance with the present invention, with the blind slats overlapping and the entire blind slat being polarized.

### DETAILED DESCRIPTION OF THE PREFERRED EMBODIMENTS

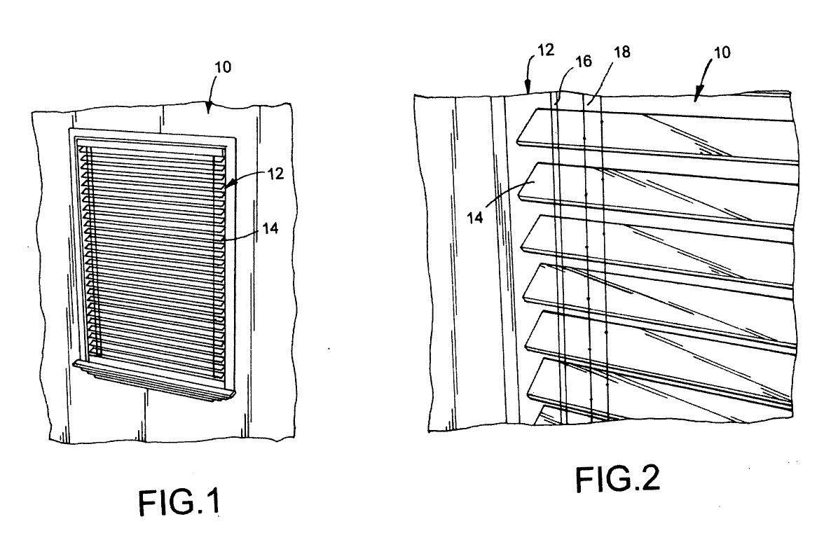

As illustrated in FIGS. 1-5, the present invention is a venetian blind system, indicated generally at 10, for enabling a user to enjoy the sun blocking benefits of the blinds, without obstructing any views of the outdoors. The venetian blind system 10 of the present invention comprises tinted and/or polarized venetian blinds 12 having blind slats 14 manufactured of a see-through tinted and/or polarized plastic material.

Offered in a vast array of styles and tinted hues, the venetian blind system 10 of the present invention features venetian blind window coverings 12 configured with either vertical or horizontal blind slats 14. In addition, the venetian blind system 10 can be constructed in a wide variety of sizes for accommodating virtually any household window, from small bathroom windows, to medium kitchen windows, to large picture windows. Like standard window treatments, the venetian blind system 10 features turning rods 16 and/or pull strings 18 for use in opening and closing the venetian blinds 12 and opening and closing the blind slats 14.

The most notable aspect of the venetian blind system 10 of the present invention is found in the function of the actual blind slats 14 of the venetian blinds 12. Preferably manufactured of a see-through tinted plastic or comparable material, the tinted venetian blind slats 14 could be a polarized, instead of tinted, coating for eliminating darker areas where the blind slats 14 overlap, if desired. As an added feature, the blind slats 14 can be coated with a special film similar to that found on mirrored sunglasses allowing users to see out of the blinds, while preventing passersby from seeing into the home or, if desired, the blind slats 14 can be coated with any color, including a wood-finished type look on the outside, as long as the user can see out of the blind slats 14.

In an alternative embodiment, the blind slats 14 of the venetian blind system 10 are clear plastic and the tint is a tinted film applied to one side or both sides of the blind slat 14. With the tint on both sides of the blind slat 14, the outside surface reflects more light making it harder to see in and the inside reflects less light making it easier to see out thereby increasing privacy without compromising the view. Also, if desired, a scratch resistant coating on the film

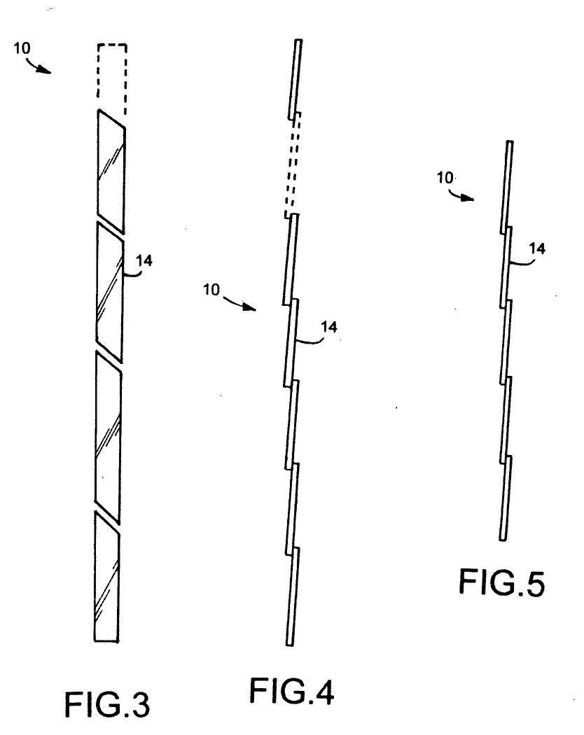

As best illustrated in FIG. 3, the venetian blind system 10 of the present invention has blind slats with slanted edges thereby avoiding overlapping blind slats 14. In this embodiment, the entire blind slat 14 is tinted. As best illustrated in FIG. 4, the blind slats 14 overlap. In order to prevent an uneven darkness, the portion of each blind slat 14 that overlaps with the adjacent blind slat 14 is left clear and free from tint. As best illustrated in FIG. 5, the blinds slats 14 are each polarized across their entire width. If each slat is polarized in the same direction, the darker areas described above are avoided.

The manner of use of the venetian blind system 10 of the present invention will now be described. It will be understood by those skilled in the art that the manner of use of the venetian blind system 10 described herein is merely one method of use and other methods of use of the venetian blind system 10 are within the scope of the present invention.

Use of venetian blind system 10 of the present invention is very simple and straightforward. First, the user determines what size venetian blinds 12 are needed by carefully measuring each window area to be covered. Once the correct size has been ascertained, the user chooses a type of venetian blinds 12 based on personal preference of style, tint, and the room in which the venetian blinds 12 will be installed. After installing the venetian blinds 12 by following package instructions, the user is ready to enjoy their new window treatments. During the daylight hours, the user closes the venetian blinds 12 in order to block the sun, without obstructing their view of the outdoors. The venetian blinds 12 are opened and closed as desired, with the homeowner choosing the positioning of the venetian blinds 12 in accordance to personal preference and need.

There are several significant benefits and advantages associated with the venetian blind system 10 of the present invention. Foremost, the venetian blind system 10 offers users attractive window coverings blocking the harmful ultraviolet rays of the sun, without preventing the user from enjoying the view out of their windows. Specially designed window blinds manufactured of see-through tinted and/or polarized plastic material, the venetian blind system 10 provides the user all of the benefits of having their blinds 12 drawn shut, without the disadvantages associated with doing so. Letting natural sunlight into the home, yet reducing glare, use of the venetian blind system 10 enables users to lower cooling bills and enjoy optimal comfort during summer months, without compromising their view or permanently tinting their windows. Homeowners will appreciate that carefully manicured landscapes, neighborhood foliage, and even passing neighbors can all be viewed and enjoyed, without letting in copious amounts of sunlight. Boasting a tint, which prevents passersby from looking in during the day, the venetian blind system 10 also serves to protect the homeowner's privacy. Curtains in addition to the venetian blind system 10 may be needed at nighttime. Although designed specifically for household use, the venetian blind system 10 can be utilized in any public or private building.

The venetian blind system 10 of the present invention offers users the ultimate combination of convenience, privacy, and style for their homes. Featuring a sophisticated design, the see-through window venetian blind system 10 reduces glare and controls sunlight, without obstructing one's view of the outdoors.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A venetian blind system for blocking the sun through a window, the venetian blind system comprising:
a plurality of blind slats;
tinting means for tinting each of the blind slats;
turning means for turning each of the blind slats together from a substantially open position to a substantially closed position;
moving means for moving each of the blind slats in a generally upward and downward direction;
wherein upon the blind slats being in a substantially closed position, any objects viewed through the window are clearly visible.

2. The venetian blind system of claim 1 wherein the plurality of blind slats are horizontal blinds, the substantially open position being when the blind slats are in the substantially horizontal position, the substantially closed position being when the blind slats are in the substantially vertical position.

3. The venetian blind system of claim 1 wherein the plurality of blind slats are vertical blinds, the substantially open position being when the blind slats are open away from each other, the substantially closed position being when the blind slats are contacting each other.

4. The venetian blind system of claim 1 wherein the tint reduces glare and filters ultraviolet rays, wherein viewing through the blind slats is obstructions free, and wherein the tint is selected from a variety of tinted hues.

5. The venetian blind system of claim 1 wherein each blind slat has a slanted edge, the entire width of each blind slat being tinted.

6. The venetian blind system of claim 1 wherein each blind slat overlaps an adjacent blind slat, a portion of one blind slat of each overlapping pair of blind slats being free from tint.

7. The venetian blind system of claim 1 wherein the tinting means is a see-through, tinted plastic material.

8. The venetian blind system of claim 1 and further comprising:
a polarized coating applied to each of the blind slats;
wherein the polarized coating reduces glare and filters ultraviolet rays; and
wherein viewing through the blind slats is obstruction free.

9. The venetian blind system of claim 8 wherein the polarization of each blind slat is in the same direction.

10. The venetian blind system of claim 1 wherein the tinting means is a tinted coating or film material applied to at least one side of each of the blind slats, wherein the coating or film material allows single direction unobstructed viewing, wherein the coating or film material obstructs viewing from the other direction.

11. A method for blocking the sun through a window, the method comprising:
providing a plurality of blind slats;
tinting each of the blind slats;
turning the blind slats from a substantially open position to a substantially closed position; and
clearly viewing objects through the window.

12. The method of claim 11 wherein the plurality of blind slats are horizontal blinds, the substantially open position being when the blind slats are in the substantially horizontal position, the substantially closed position being when the blind slats are in the substantially vertical position.

13. The method of claim 11 wherein the plurality of blind slats are vertical blinds, the substantially open position being when the blind slats are open away from each other, the substantially closed position being when the blind slats are contacting each other.

14. The method of claim 11 wherein each blind slat has a slanted edge, the entire width of each blind slat being tinted.

15. The method of claim 11 wherein the each blind slat overlaps an adjacent blind slat, a portion of one blind slat of each overlapping pair of blind slats being free from tint.

16. The method of claim 11 and further comprising:
constructing each of the blind slats from a see-through, tinted plastic material.

17. The method of claim 11 and further comprising:
applying a polarized coating to each of the blind slats;
reducing glare;
filtering ultraviolet rays; and
viewing obstruction free through the blind slats.

18. The method of claim 11 and further comprising:
applying a coating or film material to at least one side of each of the blind slats;
allowing single direction unobstructed viewing; and
allowing obstructed viewing from the other direction.

19. A venetian blind system for blocking the sun through a window, the venetian blind system comprising:
a plurality of blind slats, each of the blind slats being tinted, each of the tinted blind slats reducing glare and filtering ultraviolet rays;
a reflective coating applied to at least one side of each of the blind slats, the reflective coating obstructing passersby from looking in;
wherein upon the blind slats being in a substantially closed position, any objects viewed through the window are clearly visible from the inside looking out.

20. The venetian blind system of claim 19 and further comprising:
a coating or film material applied to at least one side of each of the blind slats;
wherein the coating or film material allows single direction unobstructed viewing; and
wherein the coating or film material obstructs viewing from the other direction.
